(19) United States
(12) Patent Application Publication
(10) Pub. No.: US 2026/0264400 A1
(43) Pub. Date: Sep. 10, 2026

(54) METHODS AND APPARATUS FOR DROPLET DEPOSITION

(71) Applicant: Xaar Technology Limited, Huntingdon (GB)

(72) Inventors: Renzo TRIP, Huntingdon (GB); Wolfgang VOIT, Huntingdon (GB); Nicholas Marc JACKSON, Huntingdon (GB)

(21) Appl. No.: 18/848,428

(22) PCT Filed: Mar. 20, 2023
(86) PCT No.: PCT/GB2023/050682

§ 371 Date: Sep. 18, 2024

(30) Foreign Application Priority Data
Mar. 21, 2022 (GB) 2203954.9

(51) Int. Cl. B41J 2/14; B29C 64/209; B33Y 30/00; B41J 2/045

(52) U.S. Cl. CPC B41J 2/14209; B29C 64/209; B33Y 30/00; B41J 2/045; B41J 2002/14225

(57) ABSTRACT

Methods and apparatus for depositing droplets of fluid onto a medium, particularly in the field printing. The apparatus includes an array of chambers having a first plurality of chambers arranged to selectively deposit droplets of fluid and a second plurality of chambers not configured for selective deposition of droplets of fluid. The first plurality of chambers are arranged in pairs separated from adjacent pairs by at least one chamber of the second plurality of chambers. Each chamber is separated from adjacent chambers by walls, the walls being actuable to eject droplets of fluid from the chambers.

### FIELD OF THE INVENTION

The present invention relates to methods and apparatuses for depositing droplets of fluid onto a medium. For example, the apparatus may include a printhead.

### BACKGROUND TO THE INVENTION

Droplet deposition heads are now in widespread usage, whether in more traditional applications, such as inkjet printing, or in materials deposition applications, such as 3D printing and other rapid prototyping techniques, and the printing of raised patterns on surfaces, e.g. braille or decorative raised patterns. In such materials deposition applications, it may be desired to deposit a relatively large amount of fluid on a medium using droplet deposition heads. In some cases, the fluids may have novel chemical properties to adhere to new mediums and increase the functionality of the deposited material.

Recently, inkjet printheads have been developed that are capable of depositing inks and varnishes directly onto ceramic tiles, with high reliability and throughput. This allows the patterns on the tiles to be customized to a customer's exact specifications, as well as reducing the need for a full range of tiles to be kept in stock.

In still other applications, droplet deposition heads may be used to form elements such as colour filters in LCD or OLED displays, e.g. as used in flat-screen television manufacturing.

It will therefore be appreciated that droplet deposition heads continue to evolve and specialise so as to be suitable for new and/or increasingly challenging deposition applications. Nonetheless, while a great many developments have been made in the field of droplet deposition heads, there remains room for improvements in the field of droplet deposition heads.

As background to the present work, a mechanism by which droplets of fluid may be ejected from an array of fluid chambers is illustrated in FIG. 1. This shows an array 10′ of fluid chambers 12 forming part of a droplet deposition head, and, underneath, a simplified representation of the same array. The chambers are bounded on one side by a substrate 15. Neighbouring fluid chambers 12 are separated by actuable side walls 14 formed of a piezoelectric material such as lead zirconate titanate (also known as PZT). The chamber 12 on each side of each piezoelectric wall 14 is coated internally with a metal layer that acts as an electrode, for applying a potential difference across the respective wall. That is to say, in this early example, within a given chamber 12 the metal electrode layer extends from the internal wall on one side of the chamber to the internal wall on the other side of the chamber (as better shown in other examples discussed herein, see e.g. FIG. 2). This, however, is by no means the only electrode configuration that can be used. For example, each electrode extending from the internal wall on one side of the chamber to the internal wall on the other side of the chamber may be cut (e.g. by laser) along the centre of the fluid chamber, effectively dividing the electrode into two independently addressable electrodes.

If the same potential is applied to the electrodes on either side of a given wall, such that there is no potential difference across the wall, the wall remains stationary. On the other hand, if different potentials are applied to the electrodes on either side of a given wall, such that a potential difference exists across the wall, the wall moves by virtue of the reverse piezoelectric effect, which transforms potential difference into movement. The walls that move may be termed “active” walls, while the walls that remain stationary may be termed “non-active” walls.

FIG. 1 illustrates a simplified representation of an array of chambers where two chambers experience a decrease in their volume due to the inward movement of their walls. As a consequence, the pressure in those two chambers increases (denoted by “+”), and the pressure in neighbouring chambers decreases (denoted by “−”). If the potential difference applied across the walls is high enough (e.g. to overcome surface tension effects), a droplet of fluid is forced out of the chamber that is under increased pressure (“+”), through a nozzle 16. Such chambers are referred to as “firing” chambers herein, because they eject (“fire”) a droplet of fluid. FIG. 1 also shows two chambers (on the far right of the diagram) that experience no change in volume because their walls remain stationary. These chambers are called “non-firing” chambers because they do not eject a droplet of fluid. It should be noted that the chambers denoted by “−” may be either firing chambers, since they are also capable of firing later in the same actuation cycle, or non-firing chambers if, in the same actuation cycle, their walls do not move in a way that causes ejection. As a particular example, where during an actuation cycle only one wall of a chamber moves, this may not cause ejection of a droplet, yet where an actuation cycle causes both walls to move, a droplet may be ejected. In another example, a droplet may be ejected when only a single wall of a chamber moves during a given actuation cycle, for example where a potential difference is applied across one wall which is large enough to cause a correspondingly large volume change for that chamber to eject a droplet.

The chambers 12 are formed as channels enclosed on one side by a cover member 17 that contacts the actuable walls; for each chamber in this example arrangement a nozzle 16 for fluid ejection is provided in this cover member 17. The cover member 17 may comprise a metal or ceramic cover plate, which provides structural support, and a thinner overlying nozzle plate, in which the nozzles are formed. Alternatively a relatively thin nozzle plate might be used on its own as a cover member.

In the example of FIG. 1 (and indeed throughout the present disclosure) each of the actuable piezoelectric walls 14 may comprise an upper half and a lower half, divided in a plane defined by the array direction (left to right in FIG. 1) and the channel extension direction (into the page in FIG. 1). The upper and lower halves of the piezoelectric walls may be poled in opposite directions perpendicular to the channel extension and array directions so that, when a potential difference is applied across the wall perpendicular to the array direction, the two halves deflect so as to bend towards one of the fluid chambers; the shape adopted by the deflected walls resembles a chevron and this may therefore be referred to as a “chevron mode” of actuation (once more this is shown in more detail in the different example shown in e.g. FIG. 2). Alternatively, each of the actuable piezoelectric walls may be poled in a unitary manner in a single direction (i.e. not as upper and lower halves poled in opposite directions) so that, when a potential difference is applied across the wall, the wall deflects in a “shear mode” of actuation.

A development of this basic idea is shown in FIG. 2. This Figure illustrates an array of fluid chambers 10 arranged to operate in a multi-cycle printing mode (specifically, a ‘shared-wall’ 3-cycle mode printing mode), in which the chambers 10 are first divided into three groups: A, B, and C, (labelled in FIG. 2) operating in different printing cycles (cycles A to C, respectively). In a 3-cycle printing mode, chambers in different groups cannot eject simultaneously on the same cycle. For example, chambers in group A can only fire in cycle A, chambers in group B can only fire in cycle B, and chambers in group C can only fire in cycle C. There is therefore a time delay between firing the chambers of groups A, B and C, indicated by the droplets ejected from the A chambers being higher (were ejected longer ago) than those from the B chambers, which are themselves higher (were ejected longer ago) than those from the C chambers. A complete firing sequence of A->B->C defines one actuation sequence for a given line of printing to be deposited on a medium. For the next line a new set of chamber activations is instructed based on the desired printing pattern and the corresponding chambers from the A group fire, followed by the corresponding B, then C chambers.

Notwithstanding this asynchronous firing scheme between the three groups, the formation of a horizontal line on the medium can be achieved by staggering the nozzles/chambers, or inputting a waveform that changes the velocity of the droplets fired in different cycles.

However, as a consequence of dividing the chambers 10 into the three groups and firing them in three staggered cycles, and since adjacent chambers cannot fire within the same cycle, the maximum print frequency of all nozzles is limited to one-third the print frequency of an individual nozzle. As a result, the printing mode results in relatively low productivity and relatively low maximum print frequency and laydown capacity.

A solution to the shortcomings of the above multi-cycle mode, to increase productivity, print frequency and laydown, is to seal-off every other chamber, which allows all remaining nozzles to fire at the same time within the same cycle. This printing mode is illustrated in FIGS. 3 and 4 and described in WO 2007/007079. FIG. 3 in particular illustrates the alternate blocking arrangement where the chamber between walls 0 and 1, 2 and 3, 4 and 5 and 6 and 7 has no nozzle, so cannot eject droplets. By contrast the chambers located between walls 1 and 2, 3 and 4 and 5 and 6 are provided with nozzles and are therefore able to eject droplets in actuation cycles. An indication of the print pattern for the current actuation cycle is shown at the lower portion of FIG. 3. Here the chambers with no nozzles are shown with an X indicating that no droplets are ever able to be ejected in those locations. The remaining chambers are allocated black (eject a droplet, e.g. by actuating the walls using the corresponding electrodes 4a, 6a) or white (do not eject a droplet, a signal may be applied on electrode 2a such that walls 1 and 2 are not actuated). Walls 3, 4, 5 and 6 are shown with a dashed outline indicating the general shape they take on when a chevron mode of actuation is used to eject droplets as part of the actuation cycle discussed herein. By contrast, walls 1 and 2 are shown with no such dashed outline to indicate that these walls are not required to move in this actuation cycle.

An actuation cycle in line with the above description is shown in FIG. 4. The cycle starts by moving all the walls of the firing chambers outwards (walls 3 and 4 move apart, as do walls 5 and 6), causing the volume of the firing chambers between those pairs to increase. This forces fluid (e.g. ink) to flow into each firing chamber. In a second part of the cycle, the walls of each firing chamber move inwards, causing a reduction in the volume of the chamber and an increase of the pressure inside the chamber, forcing the fluid out of the nozzle, much as in the multi-cycle arrangement described above. In this printing mode, active chambers are no longer shared-wall, because of the alternate chambers that are sealed-off (which reduces crosstalk caused by the proximity of the active chambers) and which are not provided with a nozzle. Every nozzle may be fired, but since the sealed-off chambers do not have a nozzle, the overall resolution is halved.

There is therefore a desire to overcome the above limitations of the various printing systems and achieve a more energy-efficient manner of printing, that is also able to eject single drops when required to do so, and to achieve simultaneous ejections of drops with a fine-grained resolution.

Further background art of relevance is provided in WO 2010/055344 A1 and WO 2018/224821 A9.

### SUMMARY OF THE INVENTION

Aspects of the present invention are set out in the appended independent claims, while particular embodiments of the invention are set out in the appended dependent claims.

Disclosed herein is an apparatus for depositing droplets of fluid onto a medium, the apparatus comprising: an array of chambers, the array including: a first subset of chambers, the first subset of chambers comprising a plurality of chambers arranged to selectively deposit droplets of fluid; and a second subset of chambers, the second subset of chambers comprising a plurality of chambers not configured for selective deposition of droplets of fluid; wherein at least one of the chambers in the first subset of chambers is an active chamber, the active chamber having a first wall adjoining a chamber from the first subset of chambers and a second wall opposed to the first wall the second wall being formed of a piezoelectric material and adjoining a chamber from the second subset of chambers; at least one of the chambers in the second subset of chambers is an inactive chamber, each inactive chamber having two opposed walls, at least one of the inactive chamber walls adjoining a chamber from the first subset of chambers; and wherein each active chamber has: a first electrode on a surface of the second wall internal to the active chamber and a second electrode on an opposed surface of the second wall, external to the active chamber; and a surface of the first wall located internally to the active chamber, the surface of the first wall having either no electrode thereon or having a third electrode thereon, the third electrode being controllable independently of the first and second electrodes or the third electrode being an electrically isolated electrode; and the apparatus being configured to provide an actuation potential independently to the first and second electrodes of each active chamber; wherein each of the second walls is actuable such that, in response to the provision of the actuation potential on the second electrode, the second wall is arranged to deform; and wherein each chamber in the first subset of chambers is in communication with an aperture for the release of droplets of fluid and is in communication with a supply of fluid to selectively deposit the fluid in response to the provision of actuation potentials to the second electrode on the second wall of each active chamber.

This arrangement allows for active chambers (i.e. those which can be controlled to selectively eject drops, depending on the input print pattern) to be arranged in pairs, separated by other chambers. An example arrangement has pairs of active chambers separated by single inactive chambers. In this arrangement, the chambers of the first and second subsets will be arranged such that pairs from the first subset are separated by individual members of the second subset and the ratio of chambers in the first subset to those in the second subset approaches 2:1 (in the limit of an infinitely long array). In other examples, the pairs of first subset chambers may be separated by more than one second subset chamber.

The array as defined above may itself be a subset of the full number of chambers in the printhead. In other words, there may be a portion of the printhead with the arrangement above, this portion being embedded within a larger array with a different configuration e.g. such as those array types discussed above.

The chambers of the first subset which do not qualify as active chambers still have many of the same properties, e.g. they are actuable independently of and simultaneously with other chambers in the first subset. The main difference is that chambers in the first subset do not necessarily adjoin both another chamber from the first subset and also a chamber from the second subset. This is because the regular pattern of the present arrangement (ideally two active, one inactive, and repeat) cannot always be maintained towards the end of the array, since the end of the array may require a different pattern of active and inactive chambers locally. However, with this point noted, the terms “active chamber” and “chamber of the first subset” are used somewhat interchangeably in this document.

Note also that the direction in which the first wall is located relative to a given chamber is independent of absolute direction. This is because, for a pair of adjacent chambers from the first subset, for simplicity labelled arbitrarily as “left” and “right”, the left chamber will have as its first wall the wall adjoining the right chamber, i.e. the right wall of the left chamber is the first wall. Similarly, for the right chamber, the first wall adjoins the left chamber and is therefore the left wall of the right chamber.

The first and second electrodes are separately controllable, which when used herein means that the electrodes of each pair are controllable separately from each other. Each chamber is also individually actuable, which in some cases, means that each first and second electrode in the array is separately controllable from every other first or second electrode of the array. In other cases, as noted below, one electrode from each pair may be coupled to a common potential while the other electrode of each pair is controllable independently each other electrode. In this manner each active chamber can be independently actuated to eject droplets by moving the second wall of that chamber to adjust the volume of that chamber. That is to say, that deformation of the second wall of a given chamber causes a change in volume of that chamber. Depending on the potential difference applied between the electrodes on either side of the second wall, the motion of the wall will make the volume of the chamber larger or smaller depending on if the second wall moves away from or toward the corresponding first wall. Based on similar principles to those discussed above, the change in volume causes a droplet to be ejected. In some cases, the ejection process may involve simply reducing the volume of a chamber, then return to neutral volume. In other cases, the chamber volume can be increased to draw in fluid, then reduced to release a droplet. This latter reduction in volume may in some cases involve a reduction back to the neutral position, while in others it may include reducing the volume below the neutral configuration.

On the first wall of each chamber, where it is not intended that the first wall is controllably moveable, there are several options each of which may be preferred depending on the specific construction method employed. For example, some construction methods may necessitate the provision of an electrode on each wall, while others may more conveniently omit electrodes in certain places. As examples of the options in this regard:
1. The first wall may have no electrodes on either side, and therefore may not be controllable at all.
2. The first wall may be formed from a de-poled piezoelectric crystal, in which the individual unit cell dipoles are randomly oriented, leading to no net response to deformations or electric fields (since the random orientations cancel out in the bulk material). Such de-poled crystals therefore do not deform even when a potential difference is applied to electrodes on opposed faces.
3. The first wall has electrodes on each face (i.e. a pair of third electrodes), but the potential on each electrode is held so that V1=V2 (for example by electrically coupling the electrodes to one another) to prevent any potential differential from being provided across the wall.
4. The first wall is formed from a poled piezoelectric material and has a pair of electrically isolated electrodes on each face (i.e. a pair of third electrodes). These are electrically isolated from all parts of the circuit. This provides additional stiffness to the first wall and reduces crosstalk between adjacent chambers of the first subset as explained below.

In yet other cases, the third electrode may be independently controllable. Usually it is not desired that this electrode is used to control the first wall in the same way as the second wall (since this would prejudice the ability to simultaneously eject drops). The third electrode can be used to compensate for induced wall motions when only one active chamber in the pair of active is a firing chamber.

Optionally, the array includes at least one pair of adjacent active chambers, the adjacent pair of active chambers being operable substantially simultaneously. In this example, “substantially simultaneously” may mean that the droplets are ejected from the two chambers at times which differ by much less than the time taken for an actuation cycle to occur (e.g. less than 10%, preferably less than 5%, and more preferably less than 1% of an actuation cycle time). In other examples, “substantially simultaneously” may mean that the adjacent chambers are ejecting droplets in such a manner that the motion of a first one of the chambers' second wall overlaps with the motion of the second one of the chambers' second wall. In other words, the time period during which one of the second walls is moving overlaps substantially with the time period during which the other of the second walls is moving (an overlap of 50%, preferably 80% more preferably 95% or more overlap). In any event, differences in the timing of droplet ejection from the two adjacent chambers is usually not more than 5 μs, preferably less than 2 μs, or even 1 μs, or less.

Optionally, one or more inactive chambers: is not in communication with a/the supply of printing fluid; has no aperture for the selective release of fluid; and/or is filled with gas or a gas mixture such as air. These arrangements each ensure that the inactive chambers are unable to eject droplets, either by not providing the inactive chambers with fluid or by allowing the inactive chambers to contain fluid, but providing them with no nozzle, outlet or aperture through which drops can be ejected onto the medium. Typically not providing an aperture is the preferred manner to achieve this effect.

Optionally, the array includes a pair of adjacent active chambers separated from another pair of adjacent active chambers by an inactive chamber. Optionally, the array includes a repeating pattern of three chambers arranged as two adjacent active chambers followed by a single inactive chamber. When this pattern is repeated for a portion of the array, the highest resolution of active chambers, consistent with the features of the present model (as disclosed herein), is achieved.

Optionally, an end chamber of the array is: a chamber of the second subset of chambers; or an active chamber and a penultimate chamber in the array is a chamber of the second subset of chambers; or wherein an endmost wall of the apparatus is moveable independently of other walls of the array. In some cases, both end chambers may be one of: a chamber of the second subset of chambers; or an active chamber and a penultimate chamber in the array is a chamber of the second subset of chambers; or wherein an endmost wall of the apparatus is moveable independently of other walls of the array (but each end chamber need not be the same one of these options as each other). This arrangement ensures that the benefits of the present system are achievable all the way to the end of an array.

In some examples, it is common practice to end an array with a moveable wall (which adjoins an inactive gap). This bears some similarities to the inactive chambers (and the chambers of the second subset) as described herein, which in turn means that the first and third options above for the end chamber(s) of the array are broadly equivalent in some cases. In other cases the first and third options may be different because the end chamber of the third example may be designed specifically for its role.

Optionally, the or each inactive chamber is different in shape and/or size to the or each active chamber. For example, the inactive chambers may be narrower, wider, longer, shorter, deeper and/or shallower than the active chambers.

Optionally, the first wall has a different width to a width of the second wall and/or wherein the first wall is formed from a different material from the material from which the second wall is formed. Thicker walls are stiffer and may help to improve isolation and reduce crosstalk. On the other hand, thinner walls result in less space being dedicated to walls. Since the first wall separates two chambers which may be firing simultaneously, the first wall may be thicker than the second wall, for example. In terms of materials, as noted above, the first wall may be made from a non-piezoelectric material or a de-poled piezoelectric material, thereby preventing the wall from deforming in response to potential differentials across the wall. In a particularly advantageous embodiment, the first wall(s) may be thinner than the second wall(s) but are provided with electrically isolated electrodes over the piezoelectric wall material. In this way, the reduced stiffness due to the thinness of the wall is compensated for by the stiffening effect of the isolated electrodes. This allows walls which are never intended to move to occupy less space, thereby improving the resolution of the array.

Optionally, the array includes adjacent chambers arranged in a row, optionally wherein the row is substantially linear. In other examples, it may be preferred that the row has the form of non-straight lines such as one or more curves, arcs, etc., depending on the intended application.

Optionally, the apparatus includes a plurality of linear rows running parallel to one another. These repeated rows work particularly well with the long, repeating 2-1-2-1 patterns described above, but find uses with the shorter lengths described herein. Each row may further be offset from the other rows in the direction of extent of the rows, and optionally each row is arranged to be actuated at differing times to cause the droplets ejected from each row to be deposited on the medium in substantially a line. The offset in the direction of the rows can be chosen to align the active chambers of one row with locations corresponding to walls or inactive chambers in another row. Because there is usually relative motion between the apparatus and the medium, the time delay between ejection of droplets in different rows corresponds to a distance offset in the direction transverse to the rows. The timing offset may therefore be chosen to align the output of the different rows in space on the medium, by taking into account the motion of the apparatus relative to the medium.

Note that the timing difference between rows is optional because there may be cases where deposition at different locations on the medium is desired. For example there may be sufficient rows that there is complete redundancy (e.g. each location is covered at the desired resolution more than once) the apparatus may be able to print two complete lines at a time, offset in space, or print at twice the frequency, each of which will affect the timing offset between rows, even to the point of no time delay being necessary or desirable between some of the rows.

Optionally, a size of the offset of the rows in the direction of extent of the rows is chosen to achieve a specific print resolution. In particular where a linear drop density in which each drop is no more than a distance x away from the nearest drop, then the offset may be chosen to be no larger than x.

In some examples there are N rows, each row includes a repeating portion having repeating units of chambers of total length D, and an offset d between rows is an integer multiple of the ratio D/N. This means that the droplets produced by each row span the full length of a repeating unit in evenly spaced increments.

Advantageously, providing active chambers in equivalent locations along a row in different rows (i.e. multiple active chambers directed at the same location on the medium) may be avoided where possible, thereby improving the resolution of the system. This means that locations of inactive chambers (and walls) in one row can be covered by one of the active chambers in a different row.

In general, where a row is formed of a repeating unit of x active chambers and y inactive chambers (x>0, y>0), it will be possible to ensure that each inactive location in a first row is covered by active locations in other rows formed from the same repeating unit, using N such rows, where:

$$if x \geq y ; N = 2 ; or$$

$$if x < y ; N = ⌈ ( x + y ) / x ⌉$$

where [ . . . ] denotes the ceiling function (i.e. always round up).

As examples of this, we present three specific arrangements of multiple rows and their offsets. In each case, the repeating unit of chambers is the present arrangement of two active, one inactive repeating unit. Also in each case it should be noted that first, second, third, etc. rows are labels of convenience and do not require that the rows are arranged in this order. In other words, the second row is not necessarily directly adjacent to (i.e. located between) the first and third rows. A four row arrangement could therefore be ordered 1-2-3-4, but also 3-1-4-2, 4-3-2-1, or any of the other possible twenty-one arrangements of four rows. Also, since the active and inactive chambers are arranged in a repeating pattern having total width D (meaning that modular arithmetic can be used to usefully describe the system), where the description below discusses offsets of a distance L in a first direction, this can equally be implemented by an offset of a different distance D-L in a second direction, opposite to the first direction.

Note that there may be several groups of rows, each row in the group offset by the same amount (and direction) in adjacent rows along the rows. This simplifies manufacturing because the etching tool can move in a single diagonal direction and etch multiple rows in one sweep without repositioning or realigning being needed.

In the first example, there are at least four parallel linear rows, and in each row a width in the direction of extent of the rows of each of the active chambers, the inactive chambers and the first and second walls are all equal to a distance d, and wherein: a second row is offset from a first row by a distance 2d in a first direction along the direction of extent of the rows; a third row is offset from the second row by a distance d in the first direction; and a fourth row is offset from the third row by a distance 2d in the first direction.

Due to the repeating nature of the rows, the fourth row is therefore offset from the first row by a distance 5d in the first direction, which equates to (−1)d in the first direction or d in a second direction opposed to the first direction along the direction of extent of the rows. This arrangement covers the whole span of the rows once every d, sometimes twice at each location. That is, once or twice at every location in the first row corresponding to an active chamber, an inactive chamber or a wall.

In a six-row variant, there are at least six parallel linear rows, and in each row a width in the direction of extent of the rows of each of the active chambers, the inactive chambers, and the first and second walls are all equal to a distance d; and wherein: a second row is offset from a first row by a distance 2d in a first direction along the direction of extent of the rows; a third row is offset from the second row by a distance 2d in the first direction; a fourth row is offset from the third row by a distance d in the first direction; a fifth row is offset from the fourth row by a distance 2d in the first direction; and a sixth row is offset from the fifth row by a distance 2d in the first direction.

The sixth row is therefore offset from the first row by a distance 9d in the first direction, which equates to 3d or (−3)d in the first direction or 3d in a second direction opposed to the first direction along the direction of extent of the rows. This covers the whole span of the rows once every d, twice at each location, i.e. at twice at every location in the first row corresponding to an active chamber, an inactive chamber or a wall.

Finally in a three-row variant, there are at least three parallel linear rows, and in each row a width in the direction of extent of the rows of each of the active chambers is a distance d, a combined width of each inactive chamber and two second walls each adjoining an active chamber is a distance 2d, and a width of each first wall adjoining an adjacent pair of active chambers is a distance 2d, and wherein: a second row is offset from a first row by a distance d in a first direction along the direction of extent of the rows; and a third row is offset from the second row by a distance d in the first direction.

The third row therefore offset from the first row by a distance 2d in the first direction, which equates to (−1)d in the first direction or d in a second direction opposed to the first direction along the direction of extent of the rows.

This covers the whole span of the rows once every d at each location, i.e. since each active chamber is evenly spaced apart from its two neighbours by a distance 2d, the offset of d between the first and second rows covers the first half of the intervening space, and the further offset of d between the second and third rows covers the second half of the intervening space.

In yet further examples, the location of the aperture in the active chambers may be located off-centre in that chamber or may otherwise be arranged to direct the ejected drops onto the medium in a manner which does not align with the centre of the active chamber. This can allow the array to evenly space the drops ejected by the array. For example, if the aperture (or indeed the drop location on the medium) is located towards the left edge of the left chamber in each pair of chambers and towards the right edge of the right chamber of each pair of chambers, then the output of the two adjacent active chambers may be shifted to partially overlap the region corresponding to the inactive chamber(s) separating the pairs of chambers. This partial overlap can be chosen such that the spacing of the left and right drops of an adjacent pair is equal to the spacing of drops between a left chamber of one pair and the right chamber of the adjacent pair (i.e. separated by one or more inactive chambers). This means that the whole length of the array can be covered in even increments, despite only two out of every three chambers (at most) being active chambers, albeit with a reduced linear drop density compared to the linear density of chambers (considering both active and inactive chambers).

Optionally, the second wall is arranged to deform in a first direction in response to a first potential difference applied across the second wall; and wherein the second wall is arranged to deform in a second direction, opposite to the first direction in response to a second potential difference applied across the second wall. The potentials supplied to the first and second electrodes are independent of one another, to allow a desired potential difference to be applied across a given wall.

In some examples the first direction corresponds to increase in volume of the active chamber (and a corresponding reduction in volume of the adjoining inactive chamber), the second direction corresponds to a reduction of the volume of the active chamber (and a corresponding reduction in volume of the adjoining inactive chamber). In other examples, the first direction corresponds to a decrease in volume of the active chamber and the second direction corresponds to an increase in volume of the active chamber. In any case, the most common firing mode in the present scheme disclosed herein is to first move the second wall of a given chamber in a direction which expands the chamber volume to draw in fluid and then subsequently to move the second wall of the chamber in an opposite direction to expel the fluid as a drop.

Optionally, one or more second walls are actuable by either: the or each first electrode being held at a fixed potential and the apparatus being arranged to provide the or each corresponding second electrode with one of a first potential higher than the fixed potential or a second potential lower than the fixed potential; or by: the or each second electrode being held at a fixed potential and the apparatus being arranged to provide the or each corresponding first electrode with one of the first potential higher than the fixed potential or the second potential lower than the fixed potential. The use of a common potential can reduce the complexity of the control circuitry. Alternatively, the apparatus is arranged to actuate one or more second walls by independently providing different potentials to one or more first and corresponding second electrodes.

Optionally, one or more third electrodes is completely electrically isolated from all other electrodes and from potential supplies. As noted above, this may provide advantages in stiffening the first wall and reducing crosstalk between the chambers.

Also disclosed herein is a method of depositing droplets of fluid onto a medium using an apparatus, the apparatus comprising: an array of chambers, the array including: a first subset of chambers, the first subset of chambers comprising a plurality of chambers arranged to selectively deposit droplets of fluid; and a second subset of chambers, the second subset of chambers comprising a plurality of chambers not configured for selective deposition of droplets of fluid; wherein at least one of the chambers in the first subset of chambers is an active chamber, the active chamber having a first wall adjoining a chamber from the first subset of chambers and a second wall opposed to the first wall the second wall being formed of a piezoelectric material and adjoining a chamber from the second subset of chambers; at least one of the chambers in the second subset of chambers is an inactive chamber, each inactive chamber having two opposed walls, at least one of the inactive chamber walls adjoining a chambers from the first subset of chambers; and wherein each active chamber has: a first electrode on a surface of the second wall internal to the active chamber and a second electrode on an opposed surface of the second wall, external to the active chamber; and a surface of the first wall located internally to the active chamber, the surface of the first wall having either no electrode thereon or having a third electrode thereon, the third electrode being controllable independently of the first and second electrodes or the third electrode being an electrically isolated electrode; and wherein the method comprises, for an actuation cycle, the steps of: receiving input data; assigning, based on said input data, all the active chambers within the first subset as either firing chambers or non-firing chambers so as to produce bands of one or more contiguous firing chambers separated by gaps corresponding to contiguous bands of chambers which are either non-firing chambers or inactive chambers; and selectively providing an actuation potential to the first and/or second electrodes, based on said input data, to actuate the second walls of the active chambers such that: for each active chamber that is assigned as a non-firing chamber, the second wall remains in a neutral position; and for each active chamber that is assigned as a firing chamber the second wall is actuated to reduce the volume of the active firing chamber and deposit a droplet of fluid; wherein actuating the second walls results in each said firing chamber releasing at least one droplet, the resulting droplets forming dots disposed on a line on said medium, said dots being separated on said line by gaps corresponding to said non-firing chambers.

It will be appreciated that this method provides many of the advantages set out above in respect of the apparatus. Note that only active chambers can be firing chambers in any given actuation cycle, however, not all active chambers are firing chambers in every actuation cycle since whether a given chamber fires in an actuation cycle depends ultimately on the pattern which is desired to be printed (which is coded into the input data). On the other hand, inactive chambers never fire, but not all non-firing chambers are inactive chambers-some non-firing chambers are active chambers corresponding to whitespace for that cycle, or do not fire because they are redundant in view of there being multiple rows of chambers.

Where a chamber is assigned as a firing chamber, the second wall of that chamber is actuated to move in the manner described generally herein to eject a droplet. Due to the adjoining nature of the walls, this means that the inactive chambers have walls which move as required to cause their adjoining chambers to eject droplets, as and when they are required to.

As noted above, there may be multiple rows of chambers forming the array. In these cases, the apparatus may either operate the rows asynchronously, thereby nevertheless forming a line on the medium by choosing the time delay between rows carefully, or it may form multiple lines, spaced apart in a direction transverse to the direction of extent of the lines on the medium. In cases where there is a time offset between rows, the actuation cycle should be thought of the time taken for all rows to fire, if they include chambers which would be scheduled to fire in that cycle. In some cases, a given row may not need to fire, but time should still be allocated to that row in the overall actuation cycle, to ensure that the system remains synchronised.

Optionally, during an actuation cycle, at least one pair of adjacent active chambers are both designated as firing chambers and each second wall of the pair of adjacent active firing chambers is actuated substantially simultaneously. As noted above, this simultaneous firing at high resolution is a hallmark of present systems, and simplifies the waveforms supplied to the printing apparatus. In some cases, during an actuation cycle all active chambers which are designated as firing chambers are actuated substantially simultaneously. As noted above, as used herein “substantially simultaneously” may mean that the droplets are ejected from the two chambers at times which differ by much less than the time taken for an actuation cycle to occur (e.g. less than 10%, preferably less than 5%, and more preferably less than 1% of an actuation cycle time). In other examples, “substantially simultaneously” may mean that the adjacent chambers are ejecting droplets in such a manner that the motion of a first one of the chambers' second wall overlaps with the motion of the second one of the chambers' second wall. In other words, the time period during which one of the second walls is moving overlaps substantially with the time period during which the other of the second walls is moving (an overlap of 50%, preferably 80% more preferably 95% or more overlap). In any event, differences in the timing of droplet ejection from the two adjacent chambers is usually not more than 5 μs, preferably less than 2 μs, or even 1 μs, or less.

The method may be carried out on any of the variants of the apparatus described above. This brings the corresponding advantages of that apparatus to the method.

### BRIEF DESCRIPTION OF THE DRAWINGS

Embodiments of the invention will now be described, by way of example only, and with reference to the drawings in which:

FIG. 1 illustrates an array of fluid chambers forming part of a droplet deposition head, with some walls of the chambers having been actuated, and beneath, a simplified representation of the same array with the same actuated walls;

FIG. 2 shows an end view of an array arranged to operate in a 3-cycle mode;

FIG. 3 shows an end view of an array of fluid chambers where every other chamber is sealed-off;

FIG. 4 illustrates the wall motions of the array of FIG. 3 which produce the drop deposition pattern shown in FIG. 3;

FIG. 5 illustrates an end view of a variant of an array in which adjacent pairs of active chambers are separated from one another by an inactive chamber, for use in the present printing mode;

FIG. 6 illustrates a plan view of the array of fluid chambers of FIG. 5, showing location of cuts to be made to separate the electrodes on the walls of each chamber;

FIG. 7 illustrates an end view of an alternate version of the array of FIG. 5, showing electrically isolated electrodes on the walls separating adjacent pairs of active chambers;

FIG. 8 illustrates a plan view of the array of fluid chambers of FIG. 7, showing location of cuts to be made to separate the electrodes on the walls of each chamber;

FIG. 9 illustrates the wall motions of the array which produce the drop deposition pattern shown in FIG. 5;

FIG. 10 illustrates a three-row arrangement of a variant of the array shown in FIG. 5;

FIG. 11 illustrates a four-row arrangement of the array shown in FIG. 5; and

FIG. 12 illustrates a six-row arrangement of the array shown in FIG. 5.

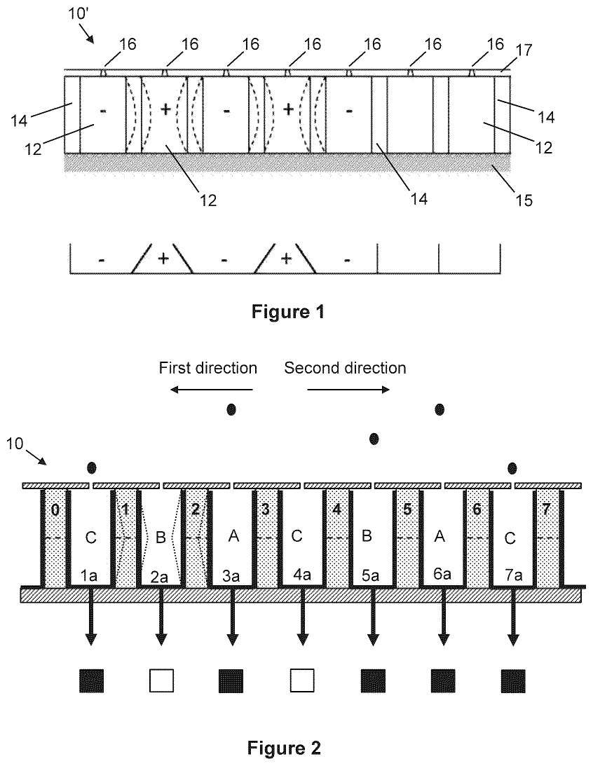

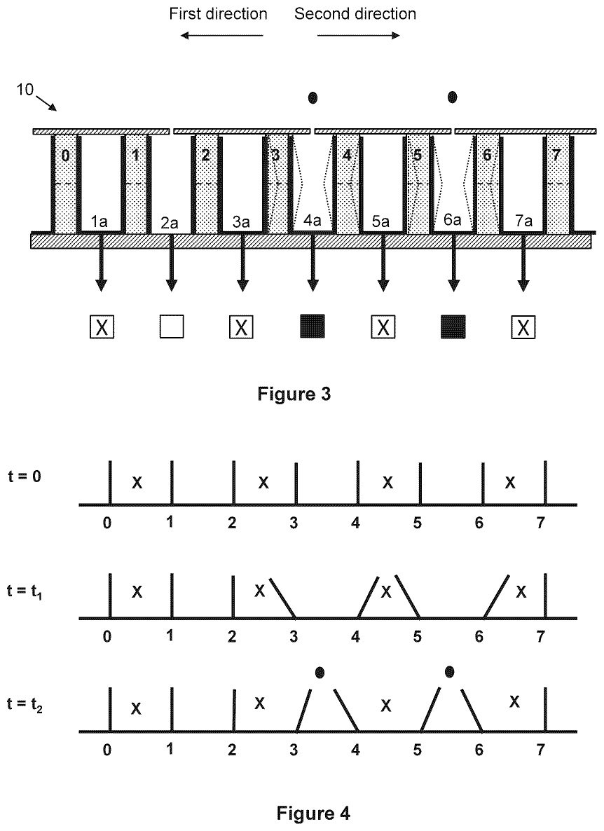

In the figures, like elements are indicated by like reference numerals throughout.

### DETAILED DESCRIPTION OF PREFERRED EMBODIMENTS

The present embodiments represent the best ways known to the Applicant of putting the invention into practice. However, they are not the only ways in which this can be achieved.

The presently described embodiments relate to a printing mode in which active chambers are arranged in adjacent pairs, separated by one or more inactive chambers.

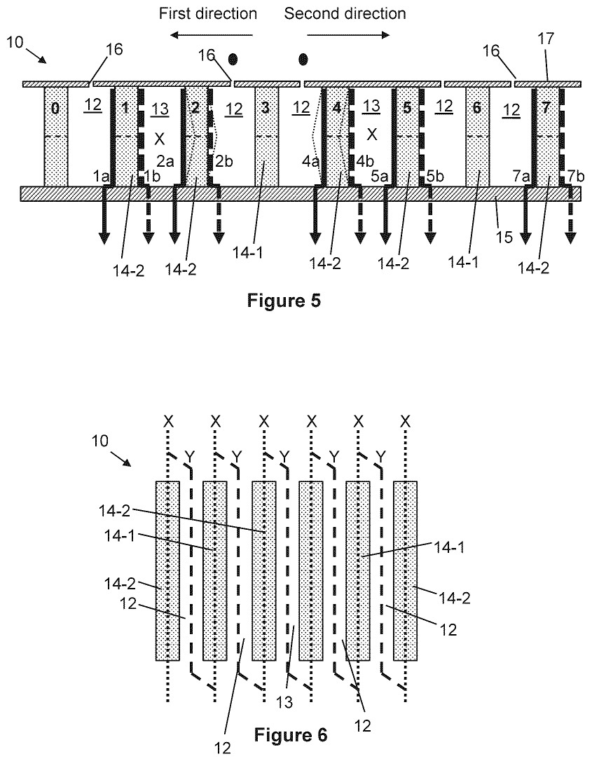

FIG. 5 shows an example of such a printhead. Here adjacent pairs of active chambers 12 are separated from one another by individual inactive chambers 13. A series of first walls 14-1 is provided located between the two active chambers 12 of a given pair of active chambers 12 and a series of second walls 14-2 is provided which separates active chambers 12 from inactive chambers 13. Each chamber is provided with two separate electrodes on opposed walls. This is achieved as shown in FIG. 6 by, in addition to the laser cuts X to separate the electrodes of one chamber 12, 13 from the electrodes of neighbouring chambers, implementing further laser cuts Y to cut the electrode for each chamber 12, 13 into two electrodes. Each of the two electrodes for a given chamber are therefore deposited on each of the two walls 14-1, 14-2 defining the chamber and separating the chamber from its neighbouring chambers 12, 13.

This leads to the arrangement shown in FIG. 5, in which each wall (labelled 0 to 7) has two electrodes—a first electrode 1a, 2a, etc., shown as a solid line located on the “first direction” side of the wall (left in FIG. 5) and a second electrode 1b, 2b, etc., shown as a dashed line located on the “second direction” side of the wall (right in FIG. 5). These electrodes are all electrically isolated from in another by the set of cuts X and Y in FIG. 6. Note that the arrangement of cuts shown in FIG. 6 results in a separated pair of electrodes located on either side of each first wall 14-1, which are not shown in FIG. 5 to highlight that the control protocols set out herein only require electrodes to be provided on the second walls 14-2. Where electrodes are formed on the first walls 14-1, these may be connected to a fixed (and equal) potential, for example, to ensure that no motion of the first walls is possible. In other examples as discussed elsewhere herein, these electrodes may be independently controlled to allow motions of one or more of the first walls 14-1 to compensate for induced wall motions when the active chamber is the only active chamber of the adjacent pair of active chambers to be firing in that actuation cycle.

As noted above, FIG. 5 shows the array 10 extending along an axis, in two opposed directions, a first direction and a second direction (left and right, respectively, in FIG. 5). In this array 10 the chambers are arranged in pairs of active chambers 12, with each pair of active chambers 12 separated from an adjacent pair of active chambers 12 by an inactive chamber 13. In the example shown there is only a single inactive chamber 13 separating the pairs of active chambers, but in some other examples, there may be more than one inactive chamber 13 separating the active chambers 12.

As shown the active chambers 12 are each provided with an aperture 16 (sometimes referred to as a nozzle or outlet) for ejection of drops of fluid, while the inactive chambers 13 have no such aperture. This means that the active chambers 12 are able to fire drops of fluid when their walls 14-1, 14-2 are actuated in accordance with protocols disclosed herein, but that the inactive chambers 13 cannot eject droplets, even in the event that their walls 14-2 are actuated. In some examples, other methods of preventing ejection of drops may be employed such as prohibiting fluid from entering the inactive chambers 13 at all, meaning that no fluid can be ejected.

There are two different types of wall 14 present in the array 10, a first wall 14-1 and a second wall 14-2. The first walls 14-1 of the array 10 are located between two active chambers 12. In other words, both sides of a first wall 14-1 are situated within different active chambers 12. The second walls 14-2 of the array 10 are located between an active chamber 12 and an inactive chamber 13, or putting this another way, a first side of each second wall 14-2 is situated within an active chamber 12 and a second side of each second wall 14-2 is situated within an adjacent inactive chamber 13. In cases where there is more than one inactive chamber 13 between the pairs of active chambers, a third type of wall would exist (linking two inactive chambers 13), but this is not discussed in detail here, as it does not change the overall picture presented herein.

As will be apparent, the fact that the second walls 14-2 are provided with two electrodes, i.e., wall 1 has a first electrode 1a on the side of the wall in the first direction and a second electrode 1b on the side of the wall in the second direction. Similarly wall 2 has a pair of electrodes 2a, 2b on opposite sides of the wall, and correspondingly walls 4, 5 and 7 have electrode pairs 4a, 4b, 5a, 5b and 7a, 7b respectively. These second walls 14-2 can therefore be arranged to deform and thereby to change the volume of the chambers 12, 13 which they adjoin. Typically the wall moves in a direction in which the higher potential is provided, so for example in the example shown in FIG. 5, if electrode 1a has a higher potential than electrode 1b, wall 1 will move in the first direction. This is merely an example however, and in some cases the opposite effect occurs depending on the poling direction of the piezoelectric material from which the wall is formed. Where no difference in potential is provided, the wall will be in a neutral position (typically illustrated as undeformed, i.e. a straight wall).

The pair of electrodes on each second wall 14-2 may be separately controllable, which when used herein means not only controllable separately from each other, but also separately from the paired electrodes of each other second wall 14-2. In this manner each active chamber can be independently actuated to eject droplets by moving the second wall 14-2 of that chamber to adjust the volume of that chamber 12. That is to say, that deformation of the second wall of a given active chamber 12 causes a change in volume of that chamber 12. Depending on the potentials applied to each electrode on the second wall 14-2, the motion of the wall 14-2 will make the volume of the chamber 12 larger or smaller depending on if the second wall 14-2 moves away from or toward the corresponding first wall 14-1. Based on similar principles to those discussed above, the change in volume causes a droplet to be ejected. In some cases, the ejection process may involve simply reducing the volume of an active chamber 12, then returning to neutral volume (the volume of the active chamber 12 when both its first 14-1 and second 14-2 walls are in their neutral position). In other cases, the chamber volume can be increased first to draw in fluid, then reduced to release a droplet. This latter reduction in volume may in some cases involve a reduction back to the neutral volume, while in others it may include reducing the volume below the neutral configuration.

This arrangement also allows a different potential to be applied to each side of each wall. A brute force approach would be to connect each electrode to an independent control signal to provide full individual control of each wall. In fact, the number of connections (and thereby the complexity of control) can be reduced by connecting the electrode on one side of each second wall (e.g. the right side electrode, shown as a dashed line, in FIG. 5) to a common, fixed potential. This arrangement allows each second wall 14-2 to be individually controlled by supplying an active potential which is either higher or lower than the common potential to the electrode on other side of that wall (e.g. solid lines, left side of the second walls 14-2 in FIG. 5 in the current example). Looking at this another way, the volume of each chamber 12 can be adjusted by supplying a corresponding potential to the active electrode of that chamber and/or by supplying a corresponding potential to the active electrode located on the other side of the wall on which the common electrode for that chamber is located. Within this framework, drop ejection works similarly to that set out above, with chambers expanding and contracting to eject a drop.

Therefore, it is clear that in some examples one electrode of each second wall 14-2 electrode pair may be connected to a common potential while the other electrode of each pair is controllable independently of other electrodes to actuate its respective second wall 14-2. Alternatively, each electrode on each second wall 14-2 may be independently controllable from all other second wall electrodes.

Note that when the motion of a second wall 14-2 causes the volume of its corresponding active chamber 12 to increase, this necessarily means that the volume of the corresponding inactive chamber 13 on the other side of the second wall 14-2 decreases. By implication the reverse is also true-when the volume of its corresponding active chamber 12 decreases, the corresponding inactive chamber 13 on the other side of the second wall 14-2 increases in volume.

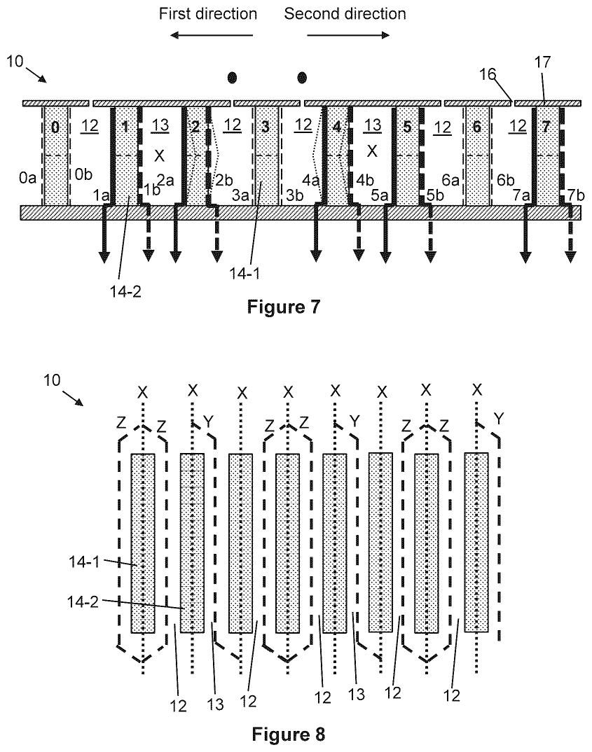

By contrast the first walls 14-1 (walls 0, 3 and 6) may have isolated electrodes from all electrical connections. This alternative arrangement is shown in FIGS. 7 and 8. FIG. 7 shows the first walls 14-1 with a pair of electrically isolated electrodes on either side of the wall, while FIG. 8 illustrates the arrangement of cuts which results in this electrode arrangement. Here, the electrodes are again formed by laser cutting additional cuts beyond the standard set of cuts X along the walls. Specifically, the additional cuts Y isolate the electrodes on adjacent second walls 14-2 from one another. Additional cuts Z are made to fully isolate the electrodes on the first walls 14-1 from all other electrodes. This in turn prevents connection of these isolated electrodes to external voltage supplies. The result of this is shown in more detail in FIG. 7, where isolated electrodes 0a,b; 3a,b; 6a,b are shown as fine dashed lines without external connections (i.e. without an arrow leading to external voltage control), while the active electrodes 1a,b; 2a,b; 4a,b; 5a,b; 7a,b are shown as wide solid or wide dashed lines with external connections represented by arrows.

In this scheme, pairs of active chambers 12 may be firing chambers and the walls are divided in two groups: the first walls 14-1 separating adjacent active chambers and the second walls 14-2 separating active and inactive chambers. In FIG. 7, the first walls 14-1 are non-actuable wall which nevertheless hold electrodes, but these electrodes are physically isolated from the tracks that transport the control signals and from each other. So, when a force is applied to these walls, the electrical isolation of the electrodes causes a charge to be induced on each isolated electrode. These charges cannot leave the isolated electrodes and generate an electric field being applied to the non-actuable wall, which in turn causes the piezoelectric material of the non-actuable wall to apply a force in opposition to the first force. Direct piezoelectric effect effectively stiffens the non-actuable walls in response to pressure in the chambers and opens the opportunity to use deeper chambers and larger sub-drop designs.

Returning now to the present arrangement, in other examples, some or all of the first walls 14-1 may include an electrode (shown in FIG. 7) on one or both of their surfaces located internal to the two active chambers 12 adjoining the first wall 14-1. In other examples, no electrodes may ever be deposited on the first walls 14-1 such that these walls 14-1 are not controllable and are therefore not actuated to move. In other examples these additional electrodes may be independently controllable, for example to provide minor correction motions to the drop ejection process to compensate for induced wall motions when only one active chamber in an adjacent pair of active is a firing chamber.

It will be apparent that the array 10 is based around a basic unit of two adjacent active chambers 12 followed by an inactive chamber 13. This basic unit may be repeated for all or a portion of the full array 10. When this pattern is repeated for a portion of the array 10, the highest resolution of active chambers, consistent with the features of the present model (as disclosed herein), is achieved for that portion of the array 10. In this optimal case, the ratio of active chambers to inactive chambers approaches 2:1 (in the limit of an infinitely long array).

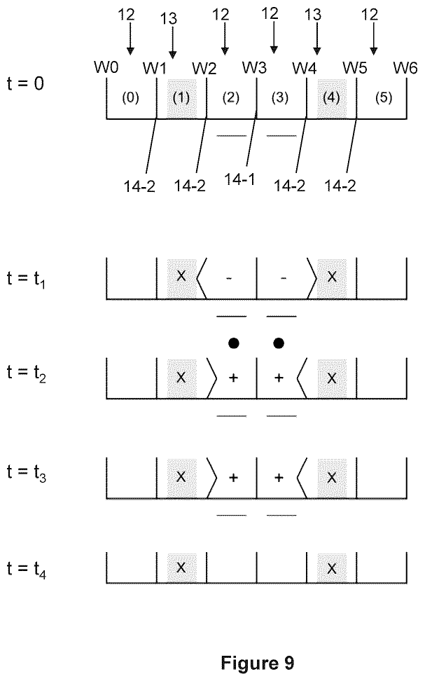

Turning now to FIG. 9, in which the firing pattern appropriate to produce the droplet ejection of FIG. 5 is shown. It will be appreciated that FIG. 9 shows a schematic of the wall actuations which would be implemented to eject droplets. The drop ejection pattern is encoded into input data. This input data effectively designates the active chambers 12 as either firing chambers (i.e. those which are intended to eject a droplet via the active chamber aperture 16) or as non-firing chambers (i.e. those which are not intended to eject a droplet). Since inactive chambers 13 cannot eject droplets because they have no outlet aperture and/or are filled with air, inactive chambers 13 cannot be designated as firing chambers. It will be appreciated that the ejected droplets will lie on a line on the medium, the line shape corresponding to the shape of the array (e.g. a straight line for a linear array). By introducing relative motion between the array 10 and the medium, in a direction transverse to the direction of extent of the line formed on the medium, a two-dimensional pattern can be printed. It is apparent that the array 10 can be configured to produce a different drop ejection pattern at different times to cover a two-dimensional area with any pattern which is desired by triggering an appropriate ejection pattern at an appropriate time. Each time period in which every chamber in the array 10 designated as a firing chamber ejects a droplet is referred to as an actuation cycle. The input data can be supplied once per actuation cycle, and each actuation cycle may have an allocation of active chambers 12 as firing or non-firing chambers independently of other actuation cycles.

For any given actuation cycle then, the input data is received and converted into appropriate trigger signals to actuate the relevant walls to cause drop ejection from the desired chambers 12. By contrast, active chambers 12 designated as non-firing chambers for that actuation cycle (as well as all inactive chambers 13) do not eject drops during that actuation cycle. Specifically, where an active chamber 12 is assigned as a firing chamber, the second wall 14-2 of that chamber 12 is actuated to move to eject a drop.

In more detail, an example of the ejection procedure is shown in FIG. 9. Here, the array 10 is shown at five different times t={0, t₁, t₂, t₃, t₄} (which are not necessarily evenly spaced in time) and with wall motions exaggerated to highlight the process. The chambers 12 are labelled with (0) to (5) and the walls are labelled W0 to W6. Chambers (1) and (4) are inactive chambers 13 and the remaining four chambers (0), (2), (3) and (5) are active chambers. Of these, (2) and (3), which are bounded by second walls 14-2 labelled W2 and W4 and separated from one another by first wall 14-1 labelled W3, are designated as firing chambers indicated by underlining beneath the array 10 at each time step. (0) and (5) are designated as non-firing chambers and are therefore not underlined.

At time t=0, the array 10 has received the input data and allocated the chambers (chambers (2) and (3)) corresponding to locations where a drop is intended to be deposited as firing chambers. Chambers (0) and (5) have been designated as non-firing chambers. Chambers (1) and (4) are inactive chambers and no allocation need be made for these chambers since they can never be firing chambers.

At time t=t₁, the array 10 has been supplied with potentials to begin the deposition process. In this example, the drop deposition begins with an expansion phase on the relevant chambers to draw additional fluid into chambers (2) and (3). Note that in doing so, the wall deformations cause a corresponding reduction in volume in the neighbouring inactive chambers (1) and (4) (marked throughout with an X to indicate their inactive status). This can be achieved by supplying the electrodes on the walls W2 and W4 with an appropriate potential. In cases where the material is such that the wall moves towards the more positive potential, the electrode located on the surface of wall W2 which is internal to chamber (1) will be supplied with a higher potential than the electrode located on the surface of wall W2 which is internal to chamber (2). Similarly, the electrode located on the surface of wall W4 which is internal to chamber (4) will be supplied with a higher potential than the electrode located on the surface of wall W4 which is internal to chamber (3). The effect of this motion is to cause a drop in pressure (indicated with a “−”) in chambers (2) and (3), thereby causing fluid to flow into these chambers. No other walls are moved in this example.

At time t=t₂, the potentials supplied to array 10 have been changed and the relevant walls have again moved to continue the deposition process. Here, walls W2 and W4 have moved past their neutral (i.e. vertical) position and now occupy positions such that the volume of chambers (2) and (3) are smaller than when the walls are in the neutral position. As before, this causes a corresponding increase in volume in the neighbouring inactive chambers (1) and (4). Consistently with the situation described in the previous time step, the electrode located on the surface of wall W2 which is internal to chamber (1) will be supplied with a lower potential than the electrode located on the surface of wall W2 which is internal to chamber (2). Similarly, the electrode located on the surface of wall W4 which is internal to chamber (4) will be supplied with a lower potential than the electrode located on the surface of wall W4 which is internal to chamber (3). The effect of this motion is to cause an increase in pressure (indicated with a “+”) in chambers (2) and (3), thereby causing fluid to flow out of these chambers via their apertures and form a drop for deposition onto the medium.

At time t=t₃, the potentials supplied in the previous step are maintained to hold the array 10 in the configuration of the previous step. This provides time for the return of the wall to be timed such that it cancels out as much of the remaining pressure wave in the chamber. Note that this step is optional, and in any case may be somewhat shorter than the other steps in the deposition process.

Finally, at time t=t₄, the potentials are changed again to allow the array 10 to return to the neutral state, ready for the next line of input data to be supplied and for the process to start again. This is indicated by the underlining representing the active firing chambers being removed ready for the next allocation of the active chambers 12 as firing or non-firing chambers.

For the sake of simplicity, at the beginning of the above actuation cycle, all walls 14 within the array 10 of fluid chambers 12, 13 are stationary in a neutral position i.e. the same potential is applied to both electrodes on the side of each wall 14, where electrodes are present. This way the volume of each fluid chamber is constant. The array is also shown as returning to this arrangement at the end, but in some cases the array 10 need not do this. In particular compensation may be applied to the motion in subsequent actuation cycles to account for the difference in initial conditions.

It can be seen in the above that the inactive chambers 13 act as a buffer to prevent crosstalk between chambers. Since the active firing chambers are actuated by moving only their second walls 14-2, which adjoin an inactive chamber 13 by definition, the active chamber pairs are able to operate simultaneously without affecting one another. Note that the walls 14 of a non-firing active chamber do not move at all in an actuation cycle, while the only walls of inactive chambers 13 that move are those that adjoin neighbouring active chamber(s) that are firing.

In this example, it is clear that the at least one pair of adjacent active chambers are both designated as firing chambers and each second wall of the pair of adjacent active firing chambers is actuated substantially simultaneously. As noted above, this simultaneous firing at high resolution is a hallmark of present systems disclosed herein, and simplifies the waveforms supplied to the printing apparatus. In some cases, during an actuation cycle all active chambers which are designated as firing chambers are actuated substantially simultaneously. As used herein “substantially simultaneously” may mean that the droplets are ejected from the two chambers at times which differ by much less than the time taken for an actuation cycle to occur (e.g. less than 10%, preferably less than 5%, and more preferably less than 1% of an actuation cycle time). In other examples, “substantially simultaneously” may mean that the adjacent chambers are ejecting droplets in such a manner that the motion of a first one of the chambers' second wall overlaps with the motion of the second one of the chambers' second wall. In other words, the time period during which one of the second walls is moving overlaps substantially with the time period during which the other of the second walls is moving (an overlap of 75%, preferably 80% more preferably 95% or more overlap). In any event, differences in the timing of droplet ejection from the two adjacent chambers is usually not more than 0.5 μs, preferably less than 0.2 μs, or even 0.1 μs, or less. Another way to think about this is that the difference in vertical location of the drops deposited on the medium is much less than the size of a drop (e.g. less than 5%, 2% or even less than 1% in some examples).

In the example illustrated in FIG. 9, the volume of firing chambers is increased to become larger than the neutral volume (a “draw step”), and then is reduced to become smaller than the neutral volume (a “release step”). However, there is no need for the draw and release steps to be implemented in this manner. For example, there may not be a need for a draw step at all, and the deposition could be implemented by simply reducing the volume of the firing chambers (e.g. an actuation cycle would comprise just the steps illustrated at times t=0 and t=t₂). Equally, a draw step may be used to draw in excess fluid, which is then expelled by returning to the neutral state. Here an actuation cycle would comprise just the steps illustrated at t=0, t=t₁, and t=t₄ (except at t=t₄ drops, not currently shown, would be formed by the firing chambers).

The array 10 has been shown thus far as being a generally linear row for simplicity, but it will be appreciated that different shape and arrangements of chambers may be formed according to the intended application, while maintaining the advantages set out herein. While the array 10 has been described primarily in the context of a single row of chambers, the array can be formed from a plurality of linear rows running parallel to one another. These repeated rows work particularly well with the long, repeating 2-1-2-1 patterns described above, but find uses with the shorter lengths described herein. Each row may further be offset from the other rows in the direction of extent of the rows, and optionally each row is arranged to be actuated at differing times to cause the droplets ejected from each row to be deposited on the medium in substantially a line. The offset in the direction of the rows can be chosen to align the active chambers of one row with locations corresponding to walls or inactive chambers in another row. Because there is usually relative motion between the apparatus and the medium, the time delay between ejection of droplets in different rows corresponds to a distance offset in the direction transverse to the rows. The timing offset may therefore be chosen to align the output of the different rows in space on the medium, by taking into account the motion of the apparatus relative to the medium and the fact that the rows themselves are spaced apart from one another in the direction transverse to the rows.

Note that the timing difference between rows is optional because there may be cases where deposition at different locations on the medium is desired. For example there may be sufficient rows that there is complete redundancy (e.g. each location is covered at the desired resolution more than once) the apparatus may be able to print two or more complete lines at a time, offset in space, or print at twice the frequency, each of which will affect the timing offset between rows, even to the point of no time delay being necessary or desirable between some of the rows. In cases where there is a time offset between rows (asynchronous firing), the actuation cycle should be thought of the time taken for all rows to fire, if they include chambers which would be scheduled to fire in that cycle. In some cases, a given row may not need to fire, but time should still be allocated to that row in the overall actuation cycle, to ensure that the system remains synchronised.

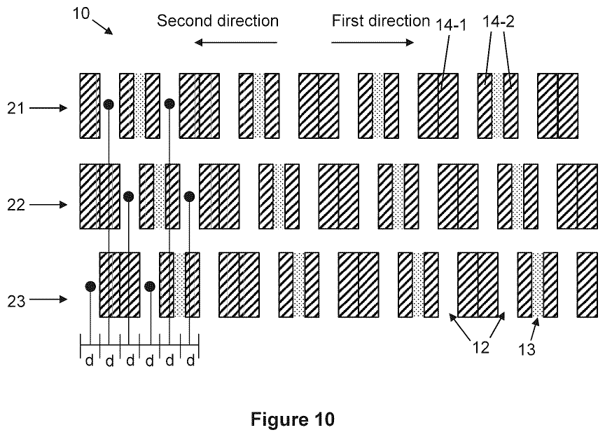

As examples of this, we present three specific arrangements of multiple rows (in FIGS. 10 to 12) and a corresponding offset arrangement to advantageously allow depositions to span the array. In each case, the repeating unit of chambers is the present system arrangement of two active, one inactive repeating unit. Also, since the active and inactive chambers are arranged in this repeating pattern having total width D (meaning that modular arithmetic can be used to usefully describe the system), where the description below discusses offsets of a distance L in a first direction, this can equally be implemented by an offset of a different distance D-L in a second direction, opposite to the first direction.

Note that there may be several distinct groups of rows, each row in the group offset by the same amount (and direction) along the rows in adjacent rows. This simplifies manufacturing because the etching tool can move in a single diagonal direction and etch multiple rows in one sweep without repositioning or realigning being needed.

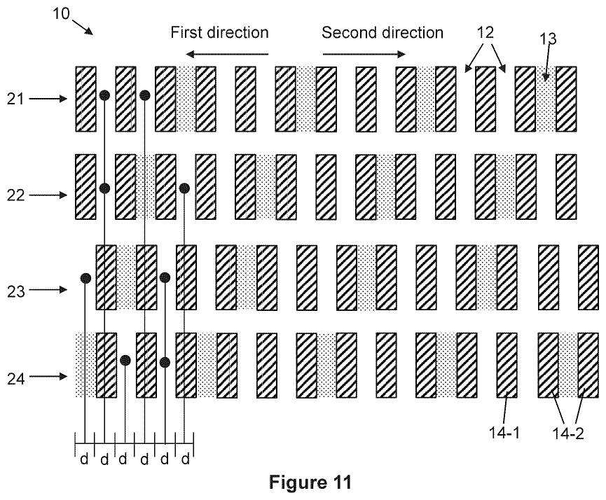

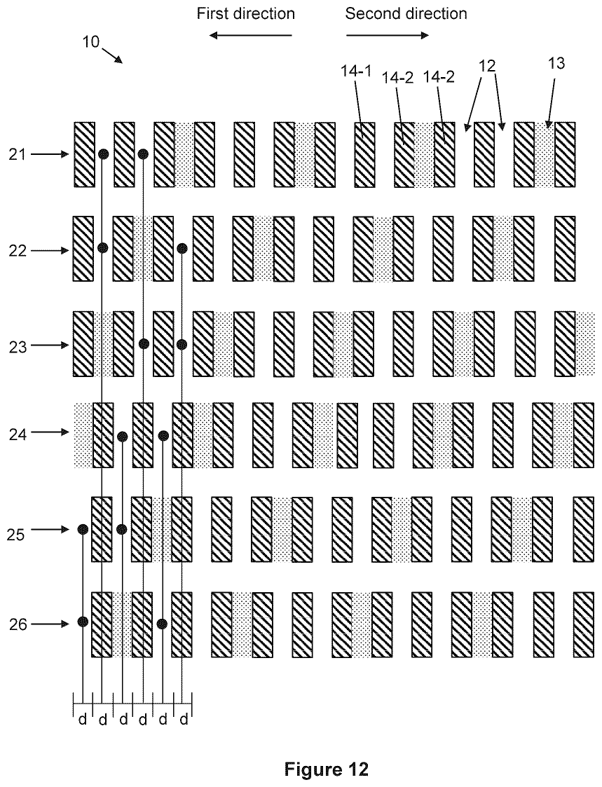

To have a uniform distribution of apertures (corresponding to uniform drop distribution), a plurality of rows may be employed. Considering only those cases in which all chambers and walls have the same width, the simplest arrangement would be a four-row layout (FIG. 11). This arrangement causes some (but not all) nozzle positions to be repeated. Alternatively, a six-row layout may be considered (FIG. 12). In this arrangement, each nozzle position is now repeated, which means twice the print resolution in the print direction can be achieved.

It is also possible to neatly span the array 10 using a 3-row layout in even increments if certain adaptations are made to the arrangement of the chambers. See for example FIG. 10, showing just such an array 10. In this three-row variant, there are (at least) three parallel linear rows 21, 22, 23. In each row a width in the direction of extent of the rows of each of the active chambers 12 (shown as whitespace in the FIG. 10) occupies a distance d, a combined width of each inactive chamber 13 (shown as dotted hatching) and two second walls 14-2 each adjoining an active chamber 12 occupies a distance 2d, and a width of each first wall 14-1 adjoining an adjacent pair of active chambers 12 also occupies a distance 2d. The second row 22 is offset from the first row 21 by a distance d in a first direction (left in the FIG. 10) along the direction of extent of the rows. A third row 23 is offset from the second row 22 by a distance d in the first direction. The third row 23 therefore offset from the first row 21 by a distance 2d in the first direction, which equates to (−4)d in the first direction or 4d in a second direction opposed to the first direction along the direction of extent of the rows (i.e. to the right in FIG. 10).

This covers the whole span of the array 10 such that a drop can be deposited once every distance d across a repeating unit. at each location, i.e. since each active chamber 12 is evenly spaced apart from its two neighbours by a distance 2d, the offset of d between the first 21 and second 22 rows covers the first half of the intervening space, and the further offset of d between the second 22 and third 23 rows covers the second half of the intervening space meaning that there are three deposition locations in a width of 3d. Because there are two active chambers 12 per repeating unit (of total width 6d), the full repeating unit is able to deposit a series of drops spaced apart from one another a distance of d. This is illustrated by the scale in the lower left of the FIG. 10, showing 6 evenly spaced distances of d, and indicating how each region of width d is associated with an active chamber 12 in the set of three rows.

Note that the inactive chambers 13 in the three-row variant are narrower than the active chambers 12. In addition, the first walls 14-1 are thicker than the second walls 14-2. This is done to ensure that the pattern repeats each distance of 6d. The line between the two halves of the first walls 14-1 are to guide the eye and show the rows are offset to align with other parts of their neighbours and do not necessarily imply that these walls 14-1 are physically separated into two halves. In general, the inactive chambers 13 may be differently shaped and/or sized to the active chambers 12 in order to achieve the desired printing density. For example, the inactive chambers 13 may be narrower (as in FIG. 10), wider, longer, shorter, deeper and/or shallower than the active chambers 12. Equally, the first walls 14-1 may have a different width to that of the second walls 14-2, to fit a desired print resolution or arrangement. As an example, the first walls 14-1 (width 2d) need not be twice the width of the active chambers 12, but could have a width of only d. This would mean that the arrangement repeats every 5d, and not 6d as in FIG. 10. This in turn would mean that instead of each consecutive row being offset from other rows by a distance d, a shorter offset of 5d/6 could be used. This in turn would increase the linear dot deposition density by about 20%, but the distribution would not be completely even since the dots from any given row would not be evenly distributed.

Turning now to FIG. 11, which shows a four-row array, it can be seen that the full repeating unit width of 6d can be spanned by four parallel linear rows in which a width in the direction of extent of the rows of each of the active chambers, the inactive chambers and the first and second walls are all equal to a distance d. Here the second row 22 is offset from the first row 21 by a distance 2d in a first direction along the direction of extent of the rows. The third row 23 is offset from the second row 22 by a distance d in the first direction. Finally, the fourth row 24 is offset from the third row 23 by a distance 2d in the first direction.

Due to the repeating nature of the rows, the fourth row 24 is therefore offset from the first row 21 by a distance 5d in the first direction, which equates to (−1)d in the first direction or d in a second direction opposed to the first direction along the direction of extent of the rows. This arrangement covers the whole span of the rows once every distance d, with 8 deposition locations spread across a distance 6d, meaning that some locations are covered by two active chambers 12, as indicated by the scale in the lower left of the FIG. 11. It is apparent that due to the offset arrangement, each different location (separated from each other by a distance d) is aligned with two walls 14 and two chambers 12, 13. In some cases the alignment is with two active chambers 12, in others the alignment is with one active chamber 12 and one inactive chamber 13.

In FIG. 12, a six-array is shown in which all the chambers 12, 13 and walls 14 have a width d, and in which each location a distance d apart is aligned with the same number of active chambers 12. In this six-row variant, there are at least six parallel linear rows, and in each row a width in the direction of extent of the rows of each of the active chambers, the inactive chambers, and the first and second walls are all equal to a distance d. Here, the second row 21 is offset from the first row 21 by a distance 2d in a first direction along the direction of extent of the rows. The third row 23 is offset from the second row 22 by a distance 2d in the first direction. The fourth row 24 is offset from the third row 23 by a distance d in the first direction. The fifth row 25 is offset from the fourth row 24 by a distance 2d in the first direction. Finally the sixth row 26 is offset from the fifth row 25 by a distance 2d in the first direction.

The sixth row 26 therefore offset from the first row 21 by a distance 9d in the first direction, which equates to 3d or (−3)d in the first direction or 3d in a second direction opposed to the first direction along the direction of extent of the rows. This covers the whole span of the rows once every d, twice at each location as shown by the scale at the lower left of the FIG. 12. It is apparent that due to the offset arrangement, each different location (separated from each other by a distance d) is aligned with three walls 14, two active chambers 12 and one inactive chamber 13.

In each of the above multi-row examples it should be noted that first, second, third, etc. rows are labels of convenience and do not require that the rows are actually arranged in this order. In other words, the second row is not necessarily directly adjacent to (i.e. located between) the first and third rows. A four-row arrangement could therefore be ordered 1-2-3-4, but also 3-1-4-2, 4-3-2-1, or any of the other possible twenty-one arrangements of four rows. In terms of the FIGS. 10 to 12, this means that any two rows can be swapped with one another (retaining their relative horizontal alignment, as well as their horizontal alignment with any other rows) while retaining a system which works in essentially the same manner as described above. In some cases a timing offset is applied to the rows to ensure that the drops produced by the rows are deposited on the medium as a single line. In this case, a correction does need to be made when rows are swapped as the vertical position of the rows is what determines this timing offset. That is, timing offsets (where present) are tied to the vertical position of a row.

In each of FIGS. 10 to 12, the scale has been exaggerated to highlight the arrangement of walls 14 and chambers 12, 13.

Finally, note that in some arrangements, a size of the offset of the rows in the direction of extent of the rows is chosen to achieve a specific print resolution. In particular where a linear drop density is desired in which each drop is no more than a distance x away from the nearest drop, then the smallest unit of offset between rows may be chosen to be no larger than x.

In yet a further generalising example, in which there are N rows, and each row includes a repeating portion having repeating units of chambers of total length D, then the offset d between rows may be chosen as an integer multiple of the ratio D/N. This means that the droplets produced by each row span the full length of a repeating unit in evenly spaced increments. Further advantageously, providing active chambers in equivalent locations along a row in different rows (i.e. multiple active chambers directed at the same location on the medium) may be avoided where possible, thereby improving the resolution of the system. This means that locations of inactive chambers (and walls) in one row can be covered by one of the active chambers in a different row, with as few repetitions as possible.

In general, for example, where a row is formed of a repeating unit of x active chambers and y inactive chambers (x>0, y>0), it will be possible to ensure that each inactive location in a first row is covered by active locations in other rows formed from the same repeating unit, using N such rows, where:

$$if x \geq y ; N = 2 ; or$$

$$if x < y ; N = ⌈ ( x + y ) / x ⌉$$

where [ . . . ] denotes the ceiling function (i.e. always round up).

In yet further examples, the location of the aperture in the active chambers may be located off-centre in that chamber or may otherwise be arranged to direct the ejected drops onto the medium in a manner which does not align with the centre of the active chamber. This can allow the array to evenly space the drops ejected by the array even when only a single row is present. For example, if the aperture (or indeed the drop location on the medium) is located towards the left edge of the left chamber in each pair of chambers and towards the right edge of the right chamber of each pair of chambers, then the output of the two adjacent active chambers may be shifted to partially overlap the region corresponding to the inactive chamber(s) separating the pairs of chambers. This partial overlap can be chosen such that the spacing of the left and right drops of an adjacent pair is equal to the spacing of drops between a left chamber of one pair and the right chamber of the adjacent pair (i.e. separated by one or more inactive chambers). This means that the whole length of the array can be spanned in even increments, despite only two out of every three chambers (at most) being active chambers, albeit with a reduced linear drop density compared to the linear density of chambers (considering both active and inactive chambers).

The print resolution in arrangements described herein can be further improved by reducing the width of the inactive chambers, the width of the active chambers, the width of the wall separating the individual active chambers (FIG. 5, walls 3, 6, etc.) or the actuated walls (FIG. 5, walls 1, 2, 4, 5, 7, etc.). As is apparent from FIG. 10, allowing for a reduction of the width of the active walls allows for a 3 row layout, where each row is configured to offer, for example a 120 dpi native print resolution. Even a 2 row layout can be achieved by reducing the width of the first wall 14-1 separating the individual active chambers.

1. An apparatus for depositing droplets of fluid onto a medium, the apparatus comprising:
an array of chambers, the array including:
a first subset of chambers, the first subset of chambers comprising a plurality of chambers arranged to selectively deposit droplets of fluid; and
a second subset of chambers, the second subset of chambers comprising a plurality of chambers not configured for selective deposition of droplets of fluid; wherein
at least one of the chambers in the first subset of chambers is an active chamber, the active chamber having a first wall adjoining a chamber from the first subset of chambers and a second wall opposed to the first wall the second wall being formed of a piezoelectric material and adjoining a chamber from the second subset of chambers;
at least one of the chambers in the second subset of chambers is an inactive chamber, each inactive chamber having two opposed walls, at least one of the inactive chamber walls adjoining a chamber from the first subset of chambers; and wherein each active chamber has:
a first electrode on a surface of the second wall internal to the active chamber and a second electrode on an opposed surface of the second wall, external to the active chamber; and
a surface of the first wall located internally to the active chamber, the surface of the first wall having either no electrode thereon or having a third electrode thereon, the third electrode being controllable independently of the first and second electrodes or the third electrode being an electrically isolated electrode; and
the apparatus being configured to provide an actuation potential independently to the first and second electrodes of each active chamber; wherein
each of the second walls is actuable such that, in response to the provision of the actuation potential on the second electrode, the second wall is arranged to deform; and wherein
each chamber in the first subset of chambers is in communication with an aperture for the release of droplets of fluid and is in communication with a supply of fluid to selectively deposit the fluid in response to the provision of actuation potential to the second electrode on the second wall of each active chamber.

2. The apparatus according to claim 1, wherein the array includes at least one pair of adjacent active chambers, the adjacent pair of active chambers being operable substantially simultaneously.

3. The apparatus according to claim 1, wherein one or more inactive chambers:
is not in communication with a/the supply of printing fluid;
has no aperture for the selective release of fluid; and/or
is filled with gas or a gas mixture such as air.

4. The apparatus according to claim 1, wherein the array includes a pair of adjacent active chambers separated from another pair of adjacent active chambers by an inactive chamber.

5. The apparatus according to claim 4, wherein the array includes a repeating pattern of three chambers arranged as two adjacent active chambers followed by a single inactive chamber.

6. The apparatus according to claim 5 wherein an end chamber of the array is:
a chamber of the second subset of chambers; or
an active chamber and a penultimate chamber in the array is a chamber of the second subset of chambers; or wherein
an endmost wall of the apparatus is moveable independently of other walls of the array.

7. The apparatus according to claim 1, wherein the or each inactive chamber is different in shape and/or size to the or each active chamber.

8. The apparatus according to claim 1, wherein the first wall has a different width to a width of the second wall and/or wherein the first wall is formed from a different material from the material from which the second wall is formed.

9. The apparatus according to claim 1, wherein the array includes adjacent chambers arranged in a row, optionally wherein the row is substantially linear.

10. The apparatus according to claim 9, wherein the apparatus includes a plurality of linear rows running parallel to one another.

11. The apparatus according to claim 10, wherein each row is offset from the other rows in the direction of extent of the rows, and optionally each row is arranged to be actuated at differing times to cause the droplets ejected from each row to be deposited on the medium in substantially a line.

12. (canceled)

13. The apparatus according to claim 11, wherein there are N rows, each row includes a repeating portion having repeating units of chambers of total length D, and an offset d between rows is an integer multiple of the ratio D/N.

14. The apparatus according to claim 11, wherein there are at least four parallel linear rows, and in each row a width in the direction of extent of the rows of each of the active chambers, the inactive chambers and the first and second walls are all equal to a distance d, and wherein:
a second row is offset from a first row by a distance 2d in a first direction along the direction of extent of the rows;
a third row is offset from the second row by a distance d in the first direction; and
a fourth row is offset from the third row by a distance 2d in the first direction.

15. The apparatus according to claim 11, wherein there are at least six parallel linear rows, and in each row a width in the direction of extent of the rows of each of the active chambers, the inactive chambers, and the first and second walls are all equal to a distance d, and wherein:
a second row is offset from a first row by a distance 2d in a first direction along the direction of extent of the rows;
a third row is offset from the second row by a distance 2d in the first direction;
a fourth row is offset from the third row by a distance d in the first direction;
a fifth row is offset from the fourth row by a distance 2d in the first direction; and
a sixth row is offset from the fifth row by a distance 2d in the first direction.

16. The apparatus according to claim 11, wherein there are at least three parallel linear rows, and in each row a width in the direction of extent of the rows of each of the active chambers is a distance d, a combined width of each inactive chamber and two second walls each adjoining an active chamber is a distance 2d, and a width of each first wall adjoining an adjacent pair of active chambers is a distance 2d, and wherein:
a second row is offset from a first row by a distance d in a first direction along the direction of extent of the rows; and
a third row is offset from the second row by a distance d in the first direction.

17. The apparatus according to claim 1, wherein the second wall is arranged to deform in a first direction in response to a first potential difference applied across the second wall; and wherein the second wall is arranged to deform in a second direction, opposite to the first direction in response to a second potential difference applied across the second wall.

18. The apparatus according to claim 17, wherein one or more second walls are actuable by either:
the or each first electrode being held at a fixed potential and the apparatus being arranged to provide the or each corresponding second electrode with one of a first potential higher than the fixed potential or a second potential lower than the fixed potential; or by:
the or each second electrode being held at a fixed potential and the apparatus being arranged to provide the or each corresponding first electrode with one of the first potential higher than the fixed potential or the second potential lower than the fixed potential.

19. The apparatus according to claim 1, wherein the apparatus is arranged to actuate one or more second walls by independently providing different potentials to one or more first and corresponding second electrodes.

20. (canceled)

21. A method of depositing droplets of fluid onto a medium using an apparatus, the apparatus comprising:
an array of chambers, the array including:
a first subset of chambers, the first subset of chambers comprising a plurality of chambers arranged to selectively deposit droplets of fluid; and
a second subset of chambers, the second subset of chambers comprising a plurality of chambers not configured for selective deposition of droplets of fluid; wherein
at least one of the chambers in the first subset of chambers is an active chamber, the active chamber having a first wall adjoining a chamber from the first subset of chambers and a second wall opposed to the first wall the second wall being formed of a piezoelectric material and adjoining a chamber from the second subset of chambers;
at least one of the chambers in the second subset of chambers is an inactive chamber, each inactive chamber having two opposed walls, at least one of the inactive chamber walls adjoining a chambers from the first subset of chambers; and wherein each active chamber has:
a first electrode on a surface of the second wall internal to the active chamber and a second electrode on an opposed surface of the second wall, external to the active chamber; and
a surface of the first wall located internally to the active chamber, the surface of the first wall having either no electrode thereon or having a third electrode thereon, the third electrode being controllable independently of the first and second electrodes or the third electrode being an electrically isolated electrode;
and wherein the method comprises, for an actuation cycle, the steps of:
receiving input data;
assigning, based on said input data, all the active chambers within the first subset as either firing chambers or non-firing chambers so as to produce bands of one or more contiguous firing chambers separated by gaps corresponding to contiguous bands of chambers which are either non-firing chambers or inactive chambers; and
selectively providing an actuation potential to the first and/or second electrodes, based on said input data, to actuate the second walls of the active chambers such that:
for each active chamber that is assigned as a non-firing chamber, the second wall remains in a neutral position; and
for each active chamber that is assigned as a firing chamber the second wall is actuated to reduce the volume of the active firing chamber and deposit a droplet of fluid; wherein
actuating the second walls results in each said firing chamber releasing at least one droplet, the resulting droplets forming dots disposed on a line on said medium, said dots being separated on said line by gaps corresponding to said non-firing chambers.

22. The method according to claim 21 wherein, during an actuation cycle at least one pair of adjacent active chambers are both designated as firing chambers and each second wall of the pair of adjacent active firing chambers is actuated substantially simultaneously.

23. (canceled)

24. (canceled)
